(19) United States
(12) Patent Application Publication
(10) Pub. No.: US 2026/0300429 A1
(43) Pub. Date: Oct. 1, 2026

(54) VECTOR PROCESSING CIRCUIT AND VECTOR PROCESSING METHOD

(71) Applicant: ANDES TECHNOLOGY CORPORATION, Hsinchu City (TW)

(72) Inventors: Heng-Kuan Lee, Hsinchu County (TW); Mengbing Yu, San Jose, CA (US); Hong-Men Su, Hsinchu County (TW); Yao-Chang Yang, Hsinchu City (TW)

(73) Assignee: ANDES TECHNOLOGY CORPORATION, Hsinchu City (TW)

(21) Appl. No.: 19/093,140

(22) Filed: Mar. 27, 2025

(51) Int. Cl. G06F 17/16

(52) U.S. Cl. CPC G06F 17/16

(57) ABSTRACT

The present disclosure proposes a vector processing circuit and a vector processing method. The circuit includes a vector register, a two-dimensional register, and an arithmetic circuit. The vector register is configured to store first data. The two-dimensional register is configured to store second data. The arithmetic circuit is configured to execute a first matrix multiplication operation on the first data and the second data. After executing the first matrix multiplication operation, the vector register is configured to store third data to replace the first data, and the arithmetic circuit is configured to execute a second matrix multiplication operation on the third data and the second data.

### BACKGROUND

### Technical Field

The present disclosure relates to a vector processing circuit and a vector processing method using two-dimensional registers.

### Related Art

With the rapid growth in demand for high computational capabilities, expanding computational power within existing processor architectures has become an urgent issue to be addressed. In vector processors, to enhance computational performance, functionality is typically expanded by increasing the number of matrix multiplication units. However, this expansion method is limited by the number of read and write ports in the vector register file (VRF), leading to reduced efficiency in data transmission to function units (FUs), thereby affecting overall computational performance. Traditional vector processors rely on vector register files to provide data, but due to the limited number of read and write ports, data access bandwidth becomes a bottleneck when executing matrix operations. Therefore, how to effectively solve this problem within the existing architecture has become an important issue in the development of vector processors.

### SUMMARY

To address the aforementioned problems, the present disclosure proposes a vector processing circuit and a vector processing method.

The present disclosure proposes a vector processing circuit, including one-dimensional vector registers, two-dimensional registers, and an arithmetic circuit. The one-dimensional vector registers store first data. The two-dimensional registers store second data. The size of the second data could be larger than or equal to the size of the first data. The arithmetic circuit is electrically connected to the one-dimensional vector registers and the two-dimensional registers, and is configured to execute a first matrix multiplication operation on the first data and the second data. After executing the first matrix multiplication operation, the one-dimensional vector registers store third data to replace the first data, and the arithmetic circuit executes a second matrix multiplication operation on the third data and the second data, wherein the first data is different from the third data.

In an embodiment of the present disclosure, the aforementioned first data belongs to at least one first row in a first matrix, and the second data belongs to multiple columns of a second matrix.

In an embodiment of the present disclosure, the aforementioned third data belongs to at least one second row in the first matrix, wherein this second row is different from the first row.

In an embodiment of the present disclosure, the quantity of the aforementioned first row is equal to 1, and the first row is the last row of the first matrix.

In an embodiment of the present disclosure, the quantity of the aforementioned first row is greater than or equal to 2, and the first rows do not include the last row of the first matrix.

In an embodiment of the present disclosure, the aforementioned two-dimensional registers includes multiple first two-dimensional registers and multiple second two-dimensional registers, and the second data includes first sub-data and second sub-data. The first sub-data is stored in the first two-dimensional registers, and the second sub-data is stored in the second two-dimensional registers. The arithmetic circuit alternately executes the first matrix multiplication operation on the first sub-data and the second sub-data. The arithmetic circuit alternately executes the second matrix multiplication operation on the first sub-data and the second sub-data.

In an embodiment of the present disclosure, the quantity of the aforementioned first two-dimensional registers is identical to a length multiplier which is configured for combining multiple vectors into a virtual vector.

In an embodiment of the present disclosure, the aforementioned one-dimensional vector registers, two-dimensional registers, and arithmetic circuit belong to a first core. The first core transmits the first data or the second data to a second core.

In an embodiment of the present disclosure, the aforementioned two-dimensional registers can be either architectural registers or non-architectural registers, allowing them to be visible to the compiler or programmer when designated as architectural registers.

In an embodiment of the present disclosure, the time of the second data being stored in the two-dimensional registers is greater than the time of the first data being stored in the vector register.

From another perspective, an embodiment of the present invention proposes a vector processing method, applicable to a vector processing circuit. This vector processing method includes: loading first data into the one-dimensional vector registers; loading second data into two-dimensional registers, wherein the size of the second data could be greater than or equal to the size of the first data; executing a first matrix multiplication operation on the first data and the second data through the vector processing circuit; and after executing the first matrix multiplication operation, loading third data into the one-dimensional vector registers to replace the first data, and executing a second matrix multiplication operation on the third data and the second data through the arithmetic circuit, wherein the first data is different from the third data.

In an embodiment of the present disclosure, the aforementioned two-dimensional registers includes multiple first two-dimensional registers and multiple second two-dimensional registers. The second data includes first sub-data and second sub-data , wherein the first sub-data is stored in the first two-dimensional registers, and the second sub-data is stored in the second two-dimensional registers. The vector processing method further includes: alternately executing the first matrix multiplication operation on the first sub-data and the second sub-data through the arithmetic circuit; and alternately executing the second matrix multiplication operation on the first sub-data and the second sub-data through the arithmetic circuit.

In an embodiment of the present disclosure, the aforementioned one-dimensional vector registers, two-dimensional registers, and arithmetic circuit belong to a first core. The vector processing method further includes: transmitting the first data or the second data from the first core to a second core.

To make the aforementioned features and advantages of the present invention more apparent and understandable, exemplary embodiments are described below in detail with reference to the accompanying drawings.

### BRIEF DESCRIPTION OF THE DRAWINGS

FIG. 1 is a block diagram illustrating a processor according to an embodiment.

FIG. 2 is a schematic diagram illustrating pseudocode for executing matrix multiplication operations according to an embodiment.

FIG. 3 is a schematic diagram illustrating data for executing matrix multiplication operations according to an embodiment.

FIG. 4 is a schematic diagram illustrating data for executing matrix multiplication operations according to an embodiment.

FIGS. 5-7 illustrate schematic diagrams of matrix multiplication operations when the length multiplier is set to 1.

FIGS. 8-9 illustrate schematic diagrams of matrix multiplication operations when the length multiplier is set to 2.

FIG. 10 illustrates a schematic diagram of a vector multiplied by a matrix when the length multiplier is set to 1.

FIG. 11 illustrates a schematic diagram of a vector multiplied by a matrix when the length multiplier is set to 8.

FIG. 12 is a schematic diagram illustrating multiple cores according to an embodiment.

FIG. 13 is a flowchart illustrating a vector processing method according to an embodiment.

### DESCRIPTION OF THE EMBODIMENTS

Some embodiments of the present invention will now be described in detail with reference to the accompanying drawings. In the following description, when the same element symbols appear in different drawings, they will be regarded as the same or similar elements. These embodiments are only a portion of the invention and do not disclose all possible implementations of the invention. More precisely, these embodiments are merely examples of the systems and methods in the scope of patent claims of the present invention.

Regarding the terms "first", "second", etc. used in this document, they do not particularly indicate order or sequence, but are merely used to distinguish elements or operations described with the same technical terms.

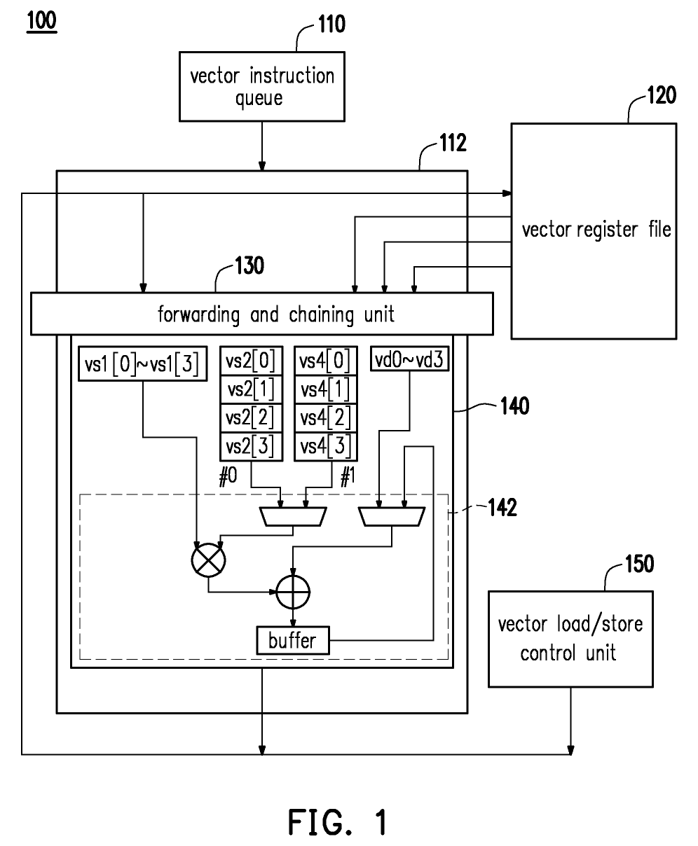

FIG. 1 is a block diagram illustrating a processor according to an embodiment. Referring to FIG. 1, a processor 100 includes a vector instruction queue 110, an issue unit 112, a vector register file 120, a forwarding and chaining unit 130, a vector processing circuit 140, and a vector load/store control unit 150. The processor 100 may be a central processing unit (CPU), a graphics processing unit (GPU), a deep-learning processing unit (DPU), a neural network processing unit (NPU), a tensor processing unit (TPU), etc. The present invention is not limited in this regard.

The vector instruction queue 110 is configured to store vector instructions. The issue unit 112 is electrically connected to the vector instruction queue 110 and is configured to decode the vector instructions from the vector instruction queue 110. For simplicity, only one issue unit 112 is shown in FIG. 1, but the present disclosure does not limit the quantity of issue units. The vector register file 120 includes multiple vector registers, where some of the vector registers are one-dimensional, while some are two-dimensional. In the architecture, the vector registers within the vector register file 120 serve as the basic unit of size. The forwarding and chaining unit 130 is electrically connected to the vector register file 120 and is configured to implement forwarding and chaining. Forwarding allows the output of an arithmetic circuit to be directly used as the input for the next instruction, without having to write the result back to the register and then read it. Chaining allows multiple functional units (FUs) to operate cooperatively.

The vector processing circuit 140 is electrically connected to the forwarding and chaining unit 130. The vector processing circuit 140 includes one-dimensional vector registers vs1[0] to vs1[3], two-dimensional registers vs2[0] to vs2[3], vs4[0] to vs[3], vector registers vd0 to vd3, and an arithmetic circuit 142. FIG. 1 is only an example, and the present disclosure does not limit the quantity and naming of each type of registers. The one-dimensional vector registers vs1[0] to vs1[3] are composed of multiple vector registers arranged in a one-dimensional structure, supporting only row-wise access operations. The two-dimensional registers vs2[0] to vs2[3], vs4[0] to vs[3] are formed by combining multiple vector registers into a two-dimensional structure, supporting either row-wise only (e.g. there is an instruction or hardware supporting the operation of transpose) or both row- and column-wise access operations, depending on the data format.

The arithmetic circuit 142 is electrically connected to the one-dimensional vector registers vs1[0] to vs1[3], two-dimensional registers vs2[0] to vs2[3], vs4[0] to vs4[3], and vector registers vd0 to vd3, and is configured to execute matrix multiplication operations. In FIG. 1, the arithmetic circuit 142 includes multiplexers, multiplication units, addition units, buffers, etc., but these units are only schematic, and the present invention does not limit which units are used to implement matrix multiplication operations. In some embodiments, the arithmetic circuit 112 is also called a functional unit, but the present disclosure does not limit the naming of the arithmetic circuit 142. The vector load/store control unit 150 is electrically connected to the forwarding and chaining unit 130 and the vector register file 120, and is configured to load data from memory or store data to memory.

In some embodiments, multiplication of two matrices is to be executed. The two matrices are referred to as a first matrix (or matrix A) and a second matrix (or matrix B). The data stored in the one-dimensional vector registers vs1[0] to vs1[3] (referred to as first data) belongs to the first matrix, while the data stored in the two-dimensional registers vs2[0] to vs2[3], vs4[0] to vs[3] (referred to as second data) belongs to the second matrix, where the size of the second data is larger than or equal to the size of the first data. Notably, the time of the second data being stored in the two-dimensional registers vs2[0] to vs2[3], vs4[0] to vs[3] is longer than the time of the first data being stored in the vector registers vs1[0] to vs1[3]. For example, the first data may be stored in the vector registers vs1[0] to vs1[3] for one or more cycles depending on the computing ability, and the second data may be stored in the two-dimensional registers vs2[0] to vs2[3], vs4[0] to vs[3] for more cycles (e.g. 10 cycles). After the arithmetic circuit 142 executes a matrix multiplication operations on the first data and the second data, the second data continue to remain in the two-dimensional registers, but the first data may be replaced (for example, replaced with third data). After the first data is replaced with the third data, the arithmetic circuit 142 executes another matrix multiplication operation on the third data and the second data. The third data is different from the first data. When intermediate results of the matrix multiplication operations are used by next or other instructions, the intermediate results may be transmitted to the vector register file 120; otherwise, the intermediate results of the matrix multiplication operations are not transmitted to the vector register file 120. In other words, the entire matrix multiplication operation could be completed in the vector processing circuit 140. Between two matrix multiplication operations, the second data is retained in the two-dimensional registers. In this way, the second data is reused without the need for frequent reading and writing from the vector register file 120, which can reduce data exchange and latency.

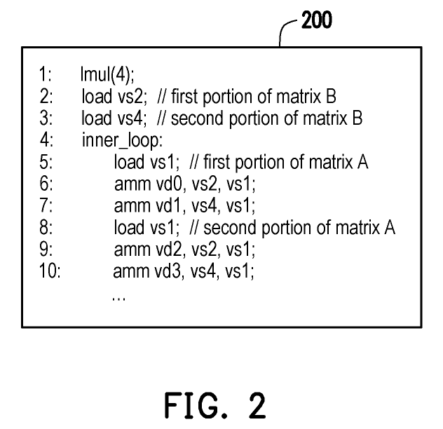

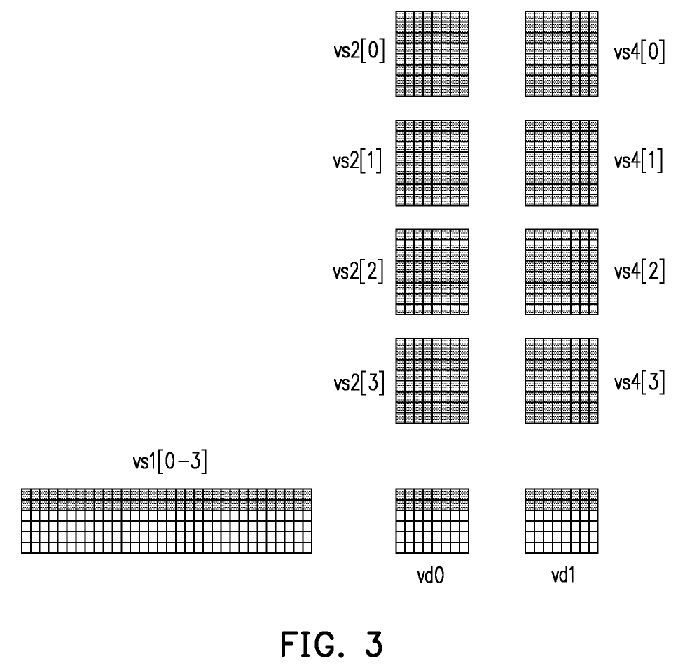

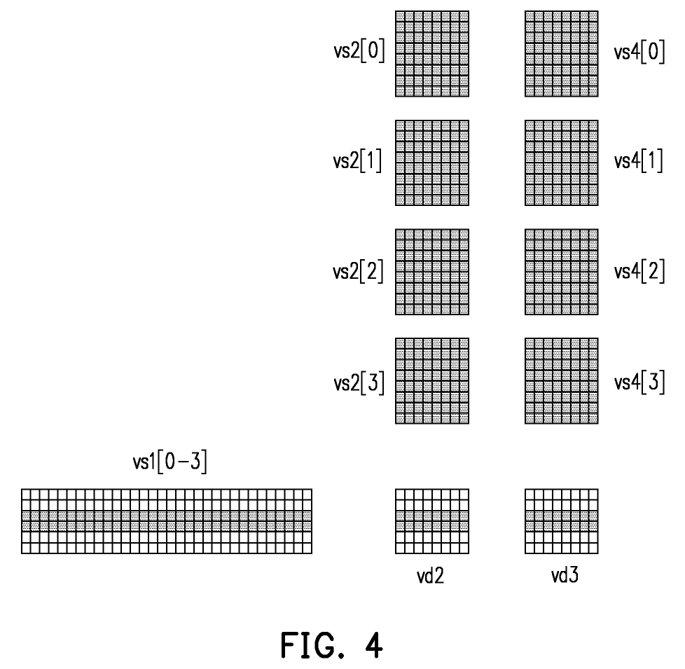

FIG. 2 is a schematic diagram illustrating pseudocode for executing matrix multiplication operations according to an embodiment. FIGS. 3 and 4 are schematic diagrams illustrating data for executing matrix multiplication operations according to an embodiment. Please refer to FIGS. 1-3. The pseudocode 200 in FIG. 2 has 10 lines. In the first line, a length multiplier is set, which is configured for combining multiple vectors into a virtual vector. In this embodiment, the length multiplier is 4, therefore 4 vector registers vs1[0] to vs1[3] form a vector register vs1, 4 two-dimensional registers vs2[0] to vs2[3] form a two-dimensional register vs2, and 4 two-dimensional registers vs4[0] to vs4[3] form a two-dimensional register vs4.

In the second line of the pseudocode 200, the vector load/store control unit 150 loads data from memory to the two-dimensional register vs2. The data stored in the two-dimensional register vs2 belongs to a first portion of matrix B, which corresponds to multiple columns of matrix B. In the third line of the pseudocode 200, the vector load/store control unit 150 loads data from memory to the two-dimensional register vs4. The data stored in the two-dimensional register vs4 belongs to a second portion of matrix B, which corresponds to multiple columns of matrix B, and this second portion is different from the aforementioned first portion. From another perspective, the aforementioned second data belongs to multiple columns of matrix B, and the second data includes a first sub-data and a second sub-data corresponding to different columns respectively. For example, the first sub-data corresponds to columns 1-8, the second sub-data corresponds to columns 9-16, where the first sub-data is stored in the two-dimensional register vs2, and the second sub-data is stored in the two-dimensional register vs4.

In the fourth line of the pseudocode 200, an inner loop is entered, which is used to process the first portion and the second portion of matrix B. In an outer loop, the data in the two-dimensional registers vs2 and vs4 may be replaced with other portions of matrix B.

In the fifth line of the pseudocode 200, the vector load/store control unit 150 loads the first data from memory to the vector register vs1. The first data stored in the vector register vs1 belongs to a first portion of matrix A, which includes at least one row of matrix A. In the embodiment shown in FIG. 3, the vector register vs1 stores data from two rows (indicated in gray), but in other embodiments, it may store data from more or fewer rows.

In the sixth line of the pseudocode 200, the arithmetic circuit 142 performs a matrix multiplication operation on the data stored in the vector register vs1 and the data stored in the two-dimensional register vs2, and stores the result in the vector register vd0 (indicated in gray). In the seventh line of the pseudocode 200, the arithmetic circuit 142 performs a matrix multiplication operation on the data stored in the vector register vs1 and the data stored in the two-dimensional register vs4, and stores the result in the vector register vd1 (indicated in gray).

Please refer to FIGS. 2 and 4. In the eighth line of the pseudocode 200, the vector load/store control unit 150 loads the third data from memory to the vector register vs1. This third data belongs to a second portion of matrix A, which stores data from two rows (indicated in gray), and the third data belongs to different rows from the first data in FIG. 3. For example, the first data may belong to rows 1-2, while the third data may belong to rows 3-4.

In the ninth line of the pseudocode 200, the arithmetic circuit 142 performs a matrix multiplication operation on the data stored in the vector register vs1 and the data stored in the two-dimensional register vs2, and stores the result in the vector register vd2 (indicated in gray). In the tenth line of the pseudocode 200, the arithmetic circuit 142 performs a matrix multiplication operation on the data stored in the vector register vs1 and the data stored in the two-dimensional register vs4, and stores the result in the vector register vd3 (indicated in gray). Subsequently, the data in the vector register vs1 may be replaced (for example, replaced with the next two rows of matrix A), and then the above operations may be repeated.

In the embodiment shown in FIGS. 2 to 4, the arithmetic circuit 142 alternately executes multiple matrix multiplication operations on the first sub-data in the two-dimensional register vs2 and the second sub-data in the two-dimensional register vs4. In other words, the two-dimensional registers are divided into two groups, with these two groups corresponding to different columns of matrix B, and the quantity of two-dimensional registers in each group is equal to the length multiplier (for example, 4). In some hardware configurations, this setup may have a higher computational density compared to grouping all two-dimensional registers into a single group.

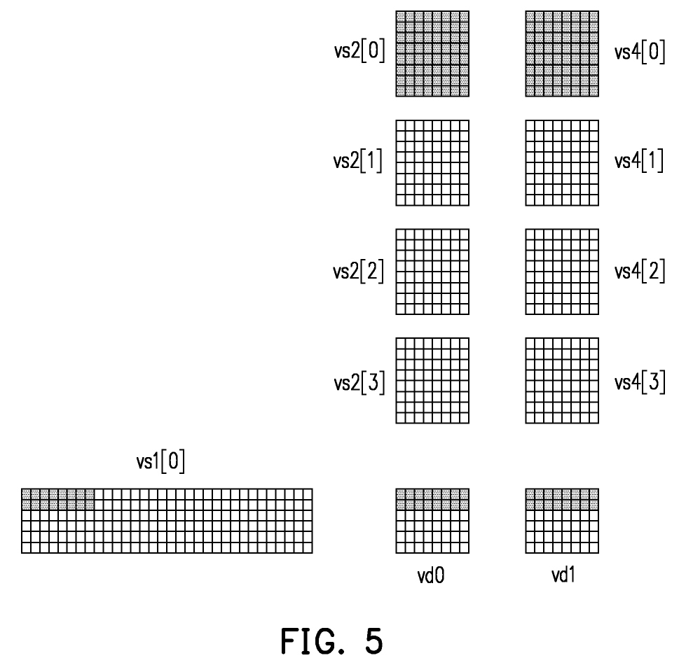

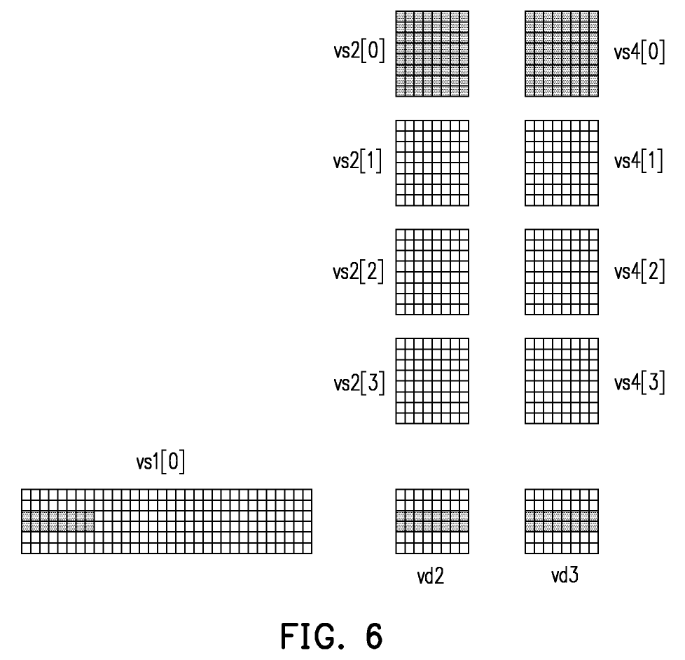

In the embodiments shown in FIGS. 3 and 4, the length multiplier is set to 4, but in other embodiments, it may be set to 1, 2, 8, or other values. For example, FIGS. 5 and 6 illustrate schematic diagrams of matrix multiplication operations when the length multiplier is set to 1. In FIG. 5, the vector register vs1[0] stores the first data, and the two-dimensional registers vs2[0] and vs4[0] store the second data. After executing a matrix multiplication operation on the first data and the second data, the first data is replaced with the third data, as shown in FIG. 6. Therefore, the second data remains in the two-dimensional registers vs2[0] and vs4[0], and the third data will undergo matrix multiplication operations with the second data. In other words, the second data is reused, which may reduce data exchange.

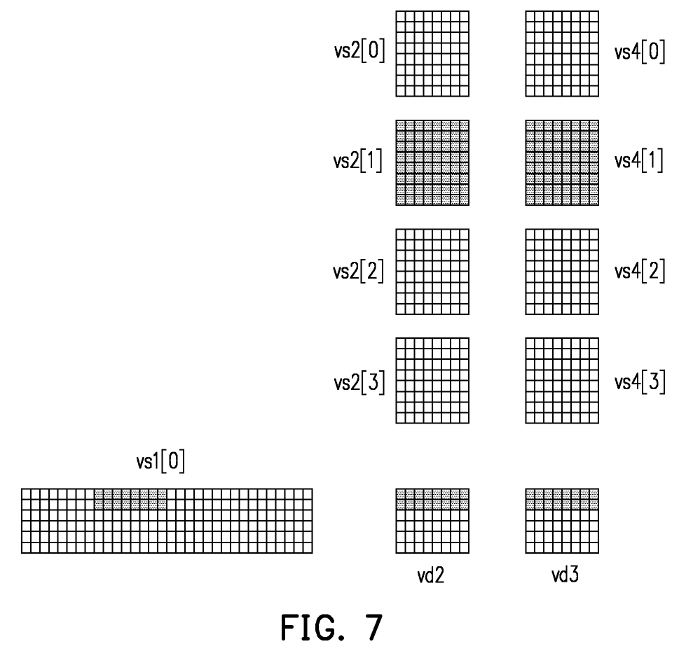

In other embodiments, after the matrix multiplication operation in FIG. 5, the data in the vector register vs1[0] may be replaced with subsequent data from the same row of matrix A. As shown in FIG. 7, the vector register vs1[0] now stores data from columns 9-16, rows 1-2. In this case, a matrix multiplication operation is performed on the data in the two-dimensional registers vs2[1] and vs4[1]. The results of the matrix multiplication operations may be stored in the vector registers vd2 and vd3, or they may be accumulated in the vector registers vd0 and vd1 from FIG. 5 (i.e., adding the results of two matrix multiplication operations). Continuing this operation, when the data from rows 1-2 of matrix A has been processed, the data from rows 3-4 will be loaded into the vector register vs1[0], at which point the data in the two-dimensional registers vs2[0] and vs4[0] is reused.

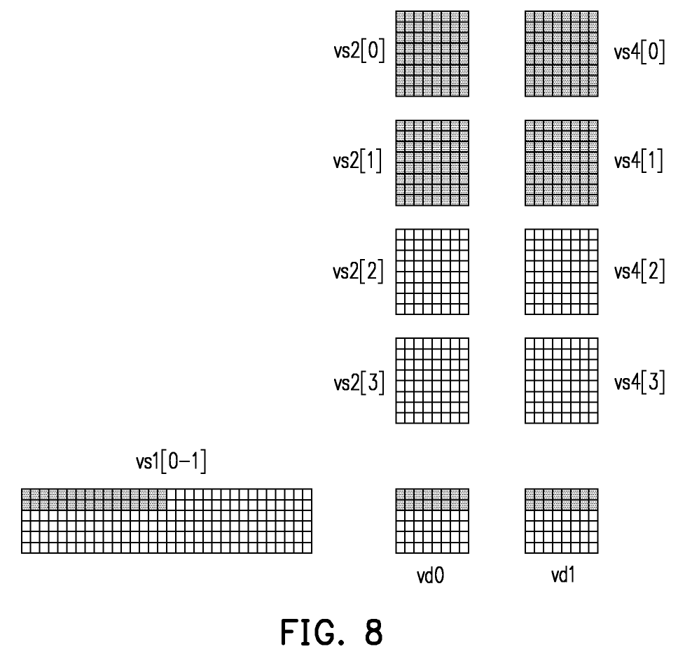

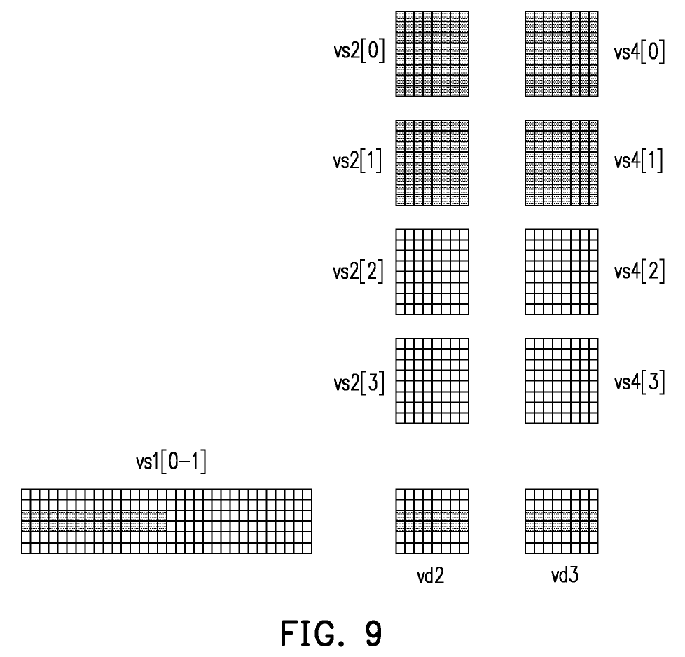

FIGS. 8 and 9 illustrate schematic diagrams of matrix multiplication operations when the length multiplier is set to 2. In FIG. 8, the vector registers vs1[0] and vs1[1] store first data, and the two-dimensional registers vs2[0], vs2[1], vs4[0], and vs4[1] store second data. After executing matrix multiplication operations on the first data and the second data, the first data is replaced with the third data, as shown in FIG. 9. The second data remains in the two-dimensional registers vs2[0], vs2[1], vs4[0], and vs4[1], while the third data will undergo matrix multiplication operations with the second data.

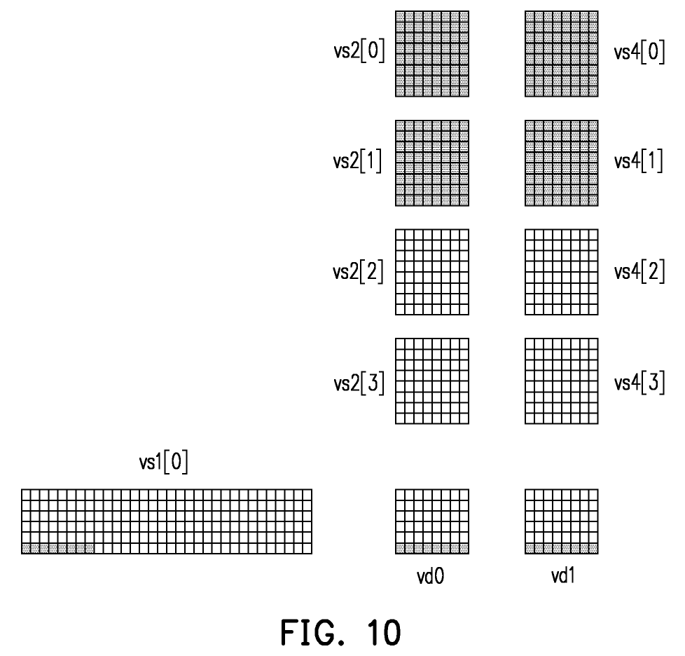

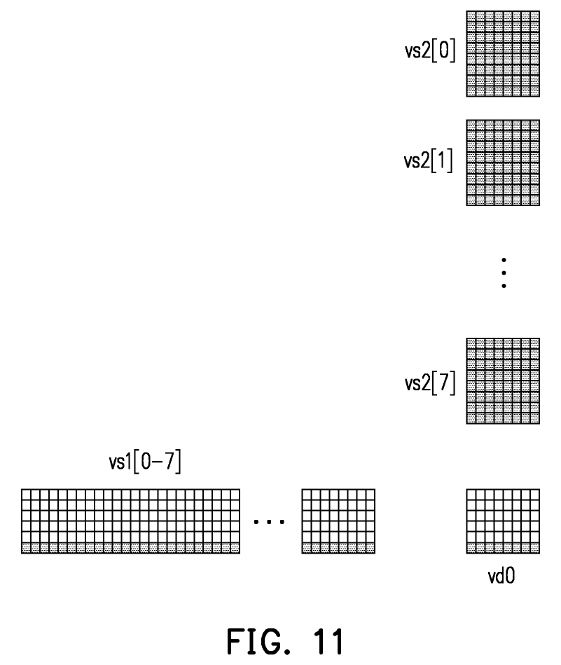

The "matrix multiplication operation" mentioned in this disclosure may include multiplication of two matrices, as well as multiplication of a vector and a matrix. For example, when processing rows of matrix A that do not include the last row, the vector register vs1 may store data from multiple rows; when processing the last row of matrix A, the vector register vs1 may store data from a single row (i.e., the last row), or the vector register vs1 may store data from multiple rows but the matrix multiplication operation in only executed on the last row. Specifically, in the aforementioned embodiments, the data stored in the vector register vs1 corresponds to 2 rows of matrix A, where matrix A has m columns, and m is a positive integer. When the positive integer m is even, the vector register vs1 stores data from two rows each time, which can process the last row of matrix A exactly. However, when the positive integer m is odd, the vector register vs1[0] may be set to store only the last row of matrix A. FIG. 10 illustrates a schematic diagram of a vector multiplied by a matrix when the length multiplier is set to 1. Referring to FIG. 10, the first data stored in the vector register vs1[0] belongs to the last row of matrix A. FIG. 11 illustrates a schematic diagram of a vector multiplied by a matrix when the length multiplier is set to 8. Referring to FIG. 11, the data stored in vector registers vs1[0] to vs1[7] belongs to the last row of matrix A.

In FIG. 11, the length multiplier is set to 8, therefore 8 two-dimensional registers vs1[0] to vs1[7] form a virtual two-dimensional register. In this embodiment, all two-dimensional registers are divided into one group, and this group of two-dimensional registers corresponds to the same columns in matrix B. However, as in the embodiments from FIGS. 3-10, these two-dimensional registers may also be divided into two groups. In other embodiments, all two-dimensional registers may also be divided into 3, 4, or more groups, with each group of two-dimensional registers corresponding to different columns in matrix B. For example, the first group may correspond to columns 1-8, the second group may correspond to columns 9-16, the third group may correspond to columns 17-24, and so on.

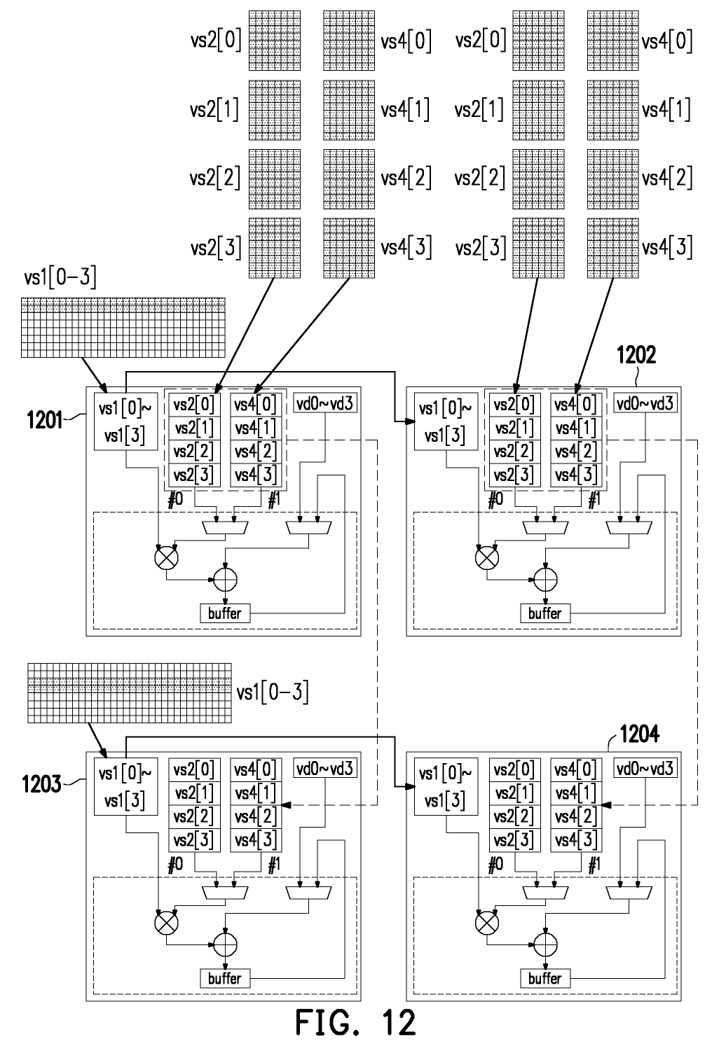

The above-mentioned embodiment is scale-up within a single core, but the aforementioned technical means may also be used for scale-out. FIG. 12 is a schematic diagram illustrating multiple cores according to an embodiment. In FIG. 12, multiple cores 1201 to 1204 are shown. When one core obtains data, it may transmit this data to other cores, avoiding the need for other cores to repeatedly load data from memory. For example, vector registers vs1[0] to vs1[3] of the core 1201 are used to store data from rows 1-2 of matrix A, and after receiving this data, the data is transmitted to vector registers vs1[0] to vs1[3] of the core 1202. Vector registers vs1[0] to vs1[3] of the core 1203 are used to store data from rows 3-4 of matrix A, and after receiving this data, the data is transmitted to vector registers vs1[0] to vs1[3] of the core 1204. On the other hand, two-dimensional registers vs2[0] to vs2[3] of the core 1201 are used to store data from columns 1-8 of matrix B, and this data may be transmitted to two-dimensional registers vs2[0] to vs2[3] of the core 1203. Two-dimensional registers vs4[0] to vs4[3] of the core 1201 are used to store data from columns 9-16 of matrix B, and this data may be transmitted to two-dimensional registers vs4[0] to vs4[3] of the core 1203. Two-dimensional registers vs2[0] to vs2[3] of the core 1202 are used to store data from columns 17-24 of matrix B, and this data may be transmitted to two-dimensional registers vs2[0] to vs2[3] of the core 1204. Two-dimensional registers vs4[0] to vs4[3] of core 1202 are used to store data from columns 25-32 of matrix B, and this data may be transmitted to two-dimensional registers vs4[0] to vs4[3] of the core 1204. In this way, the cores 1201 to 1204 may operate in parallel, simultaneously processing the multiplication of matrix A and matrix B.

From another perspective, multiple cores 1201 to 1204 may be divided into multiple rows and multiple columns. Data stored in vector registers vs1[0] to vs1[3] within a certain core may be transmitted to vector registers vs1[0] to vs1[3] within other cores in the same row. Data stored in two-dimensional registers vs2[0] to vs2[3] and vs4[0] to vs4[3] within a certain core may be transmitted to two-dimensional registers vs2[0] to vs2[3] and vs4[0] to vs4[3] within other cores in the same column.

Please refer to FIGS. 2 and 3. In this embodiment, the two-dimensional registers vs2 and vs4 are accessible by program codes. However, in some embodiments, the two-dimensional registers vs2 and vs4 are designed to be inaccessible by the program code. Such registers are called shadow registers or non-architecture registers. When adopting the non-architecture register design, the compiler needs to be aware of the existence of the two-dimensional registers vs2 and vs4. For example, a programmer may use other names of architecture registers rather than vs2 and vs4 in the pseudo code 200 in FIG. 2. The data in the architecture registers would be mapped to the registers vs2 and 4. Therefore, the two-dimensional registers vs2 and vs4 are stilled used when performing matrix multiplication operations. From another perspective, when the two-dimensional registers vs2 and vs4 are architecture registers, they are accessed in response to a first instruction; when two-dimensional registers vs2 and vs4 are non-architecture registers, they are accessed in response to a second instruction in conjunction with the compiler. The first instruction is different from the second instruction, where the first instruction specifies two-dimensional registers vs2 and vs4, but the second instruction does not specify two-dimensional registers vs2 and vs4.

When the two-dimensional registers vs2 and vs4 are non-architecture registers and divided into multiple groups as in the embodiments of FIGS. 3-10, the sizes and the number of the groups are mapped to the vector processor file. For example, one architecture register is mapped to the first group, and another architecture register is mapped to the second group, and so on. When the two-dimensional registers vs2 and vs4 are architecture registers and divided into multiple groups, the sizes and the number of the groups are determined based on implementation factors such as cost and encoding space.

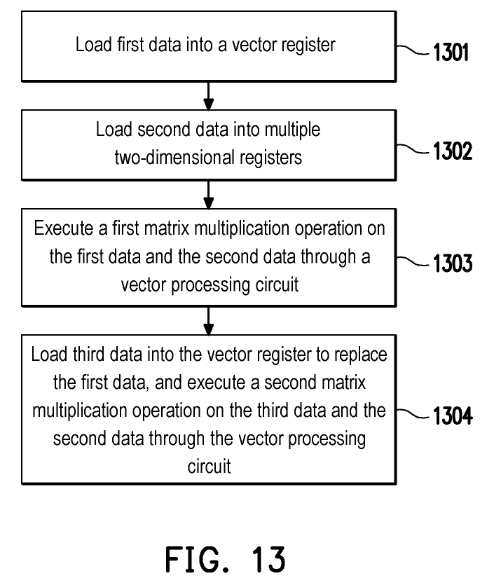

FIG. 13 is a flowchart illustrating a vector processing method according to an embodiment. Please refer to FIG. 13, this vector processing method is applicable to the processor in FIG. 1. In step 1301, first data is loaded into a vector register. In step 1302, second data is loaded into multiple two-dimensional registers, wherein the size of the second data is larger than the size of the first data. In step 1303, a first matrix multiplication operation is executed on the first data and the second data through a vector processing circuit. In step 1304, after executing the first matrix multiplication operation, third data is loaded into the vector register to replace the first data, and a second matrix multiplication operation is executed on the third data and the second data through the vector processing circuit, wherein the first data is different from the third data. Each step in FIG. 13 has been explained in detail as above, so the description will not be repeated here. It is worth noting that each step in FIG. 13 may be implemented as multiple codes or circuits, and the present disclosure is not limited in this regard. In addition, the method of FIG. 13 may be used in conjunction with the above embodiments or used independently. In other words, other steps may also be added between the steps of FIG. 13.

In the above-mentioned vector processing circuit and vector processing method, data stored in the two-dimensional registers are reused, thereby reducing data exchange and lowering the read/write port requirements for the vector register file.

Although the present invention has been disclosed by the above embodiments, it is not intended to limit the present invention. Any person skilled in the art may make minor modifications and refinements without departing from the spirit and scope of the present invention. Therefore, the protection scope of the present invention should be defined by the appended claims.

What is claimed is:

1. A vector processing circuit in a processor, the vector processing circuit comprising:
a vector register, configured to store first data;
a plurality of two-dimensional registers, configured to store second data, wherein a size of the second data is larger than or equal to a size of the first data; and
an arithmetic circuit, electrically connected to the vector register and the two-dimensional registers, and configured to execute a first matrix multiplication operation on the first data and the second data,
wherein after executing the first matrix multiplication operation, the vector register is configured to store third data to replace the first data, the arithmetic circuit is configured to execute a second matrix multiplication operation on the third data and the second data, wherein the first data is different from the third data.

2. The vector processing circuit according to claim 1, wherein the first data belongs to at least one first row in a first matrix, and the second data belongs to a plurality of columns of a second matrix.

3. The vector processing circuit according to claim 2, wherein the third data belongs to at least one second row in the first matrix, and the at least one second row is different from the at least one first row.

4. The vector processing circuit according to claim 2, wherein a quantity of the at least one first row is equal to 1, and the first row belongs to a last row of the first matrix.

5. The vector processing circuit according to claim 2, wherein a quantity of the at least one first row is greater than or equal to 2, and the first rows do not include a last row of the first matrix.

6. The vector processing circuit according to claim 2, wherein the two-dimensional registers include a plurality of first two-dimensional registers and a plurality of second two-dimensional registers, the second data includes a first sub-data and a second sub-data, the first sub-data is stored in the first two-dimensional registers, and the second sub-data is stored in the second two-dimensional registers,
wherein the arithmetic circuit alternately executes the first matrix multiplication operation on the first sub-data and the second sub-data,
wherein the arithmetic circuit alternately executes the second matrix multiplication operation on the first sub-data and the second sub-data.

7. The vector processing circuit according to claim 6, wherein a quantity of the first two-dimensional registers is identical to a length multiplier configured for combining a plurality of vectors into a virtual vector.

8. The vector processing circuit according to claim 1, wherein the vector register, the two-dimensional registers, and the arithmetic circuit belong to a first core, and the first core is configured to transmit the first data or the second data to a second core.

9. The vector processing circuit according to claim 1, wherein the two-dimensional registers are non-architectural registers.

10. The vector processing circuit according to claim 1, wherein time of the second data being stored in the two-dimensional registers is longer than time of the first data being stored in the vector register.

11. A vector processing method for a vector processing circuit, the vector processing method comprising:
loading first data into a vector register;
loading second data into a plurality of two-dimensional registers, wherein a size of the second data is greater than or equal to a size of the first data;
executing a first matrix multiplication operation on the first data and the second data by the vector processing circuit; and
after executing the first matrix multiplication operation, loading third data into the vector register to replace the first data, and executing a second matrix multiplication operation on the third data and the second data by the vector processing circuit, wherein the first data is different from the third data.

12. The vector processing method according to claim 11, wherein the first data belongs to at least one first row in a first matrix, and the second data belongs to a plurality of columns of a second matrix.

13. The vector processing method according to claim 12, wherein the third data belongs to at least one second row in the first matrix, and the at least one second row is different from the at least one first row.

14. The vector processing method according to claim 12, wherein a quantity of the at least one first row is equal to 1, the first row belongs to a last row of the first matrix.

15. The vector processing method according to claim 12, wherein a quantity of the at least one first row is greater than or equal to 2, and the first rows do not include a last row of the first matrix.

16. The vector processing method according to claim 12, wherein the two-dimensional registers include a plurality of first two-dimensional registers and a plurality of second two-dimensional registers, the second data includes a first sub-data and a second sub-data , the first sub-data is stored in the first two-dimensional registers, the second sub-data is stored in the second two-dimensional registers, the vector processing method further comprising:
executing the first matrix multiplication operation on the first sub-data and the second sub-data alternately by the arithmetic circuit; and
executing the second matrix multiplication operation on the first sub-data and the second sub-data alternately by the arithmetic circuit.

17. The vector processing method according to claim 16, wherein a quantity of the first two-dimensional registers is identical to length multiplier configured for combining a plurality of vectors into a virtual vector.

18. The vector processing method according to claim 11, wherein the vector register, the two-dimensional registers, and the arithmetic circuit belong to a first core, the vector processing method further comprising:
transmitting the first data or the second data from the first core to a second core.

19. The vector processing method according to claim 11, wherein the two-dimensional registers are non-architectural registers.

20. The vector processing method according to claim 11, wherein time of the second data being stored in the two-dimensional registers is longer than time of the first data being stored in the vector register.
